(19) United States
(12) Patent Application Publication
(10) Pub. No.: US 2026/0168783 A1
(43) Pub. Date: Jun. 18, 2026

(54) COHERENT OUTSIDE-THE-LENS IMAGING OF MOIRÉ TARGETS FOR OVERLAY METROLOGY

(71) Applicant: KLA Corporation, Milpitas, CA (US)

(72) Inventors: Nireekshan K. Reddy, Tel Aviv (IL); Yonatan Vaknin, Yoqneam Illit (IL); Vladimir Levinski, Migdal Haemek (IL); David Koprivica, Petah Tikva (RS); Alon Alexander Volfman, Migdal Haemek (IL); Andrew V. Hill, Berkley, CA (US)

(21) Appl. No.: 18/986,348

(22) Filed: Dec. 18, 2024

(51) Int. Cl. G01B 9/02; G01B 11/27

(52) U.S. Cl. CPC G01B 9/02041; G01B 11/272

(57) ABSTRACT

An overlay metrology system may include an illumination source configured to generate one or more illumination beams, an objective lens, an illumination sub-system, and an imaging system to generate one or more images of an overlay target having one or more Moiré structures, where a particular image is based on two selected mutually coherent diffraction lobes per measurement direction associated with one or more illumination beams rotated azimuthally with respect to one or more measurement directions. The system may further include a controller to generate one or more overlay measurements based on the one or more images.

### TECHNICAL FIELD

The present disclosure relates generally to overlay metrology and, more particularly, to dark-field imaging overlay metrology of Moiré targets with rotated mutually coherent oblique illumination.

### BACKGROUND

Overlay metrology systems typically characterize the overlay alignment of multiple layers of a sample by measuring the relative positions of overlay target features located on layers of interest. As the size of fabricated features decreases and the feature density increases, the demands on overlay metrology systems needed to characterize these features increase. Accordingly, it is desirable to develop systems and methods to address these demands.

### SUMMARY

In embodiments, the techniques described herein relate to an overlay metrology system including an illumination source configured to generate one or more illumination beams; an objective lens; an illumination sub-system including one or more illumination lenses to illuminate an overlay target with the one or more illumination beams outside a numerical aperture of the objective lens from opposing azimuth incidence angles rotated relative to one or more measurement directions, where the overlay target in accordance with a metrology recipe includes one or more Moiré structures formed as overlapping grating structures with a first pitch and a second pitch; an imaging sub-system including one or more detectors configured to generate one or more images of the overlay target based on light collected by the objective lens, where a particular image of the one or more images is based exclusively on two selected mutually coherent diffraction lobes per measurement direction for at least one of the one or more measurement directions; and a controller including one or more processors configured to execute program instructions causing the one or more processors to generate one or more overlay measurements associated with the one or more measurement directions based on the one or more images.

In embodiments, the techniques described herein relate to an overlay metrology system, where the one or more images include a first image and a second image, where the imaging sub-system includes a first imaging channel to form the first image and a second imaging channel to form the second image.

In embodiments, the techniques described herein relate to an overlay metrology system, where the two selected mutually coherent diffraction lobes associated with the first image include diffraction lobes associated with diffraction of a first of the one or more illumination beams at the first pitch and the second pitch, where the two selected mutually coherent diffraction lobes associated with the second image include diffraction lobes associated with diffraction of a second of the one or more illumination beams at the first pitch and the second pitch.

In embodiments, the techniques described herein relate to an overlay metrology system, where the first of the one or more illumination beams and the second of the one or more illumination beams have different wavelengths.

In embodiments, the techniques described herein relate to an overlay metrology system, where the first of the one or more illumination beams and the second of the one or more illumination beams have different polarizations.

In embodiments, the techniques described herein relate to an overlay metrology system, where the one or more illumination beams are mutually coherent, where the two selected mutually coherent diffraction lobes associated with the first image include a diffraction lobe associated with the first pitch from a first of the one or more illumination beams and a diffraction lobe associated with the second pitch from a second of the one or more illumination beams, where the two selected mutually coherent diffraction lobes associated with the second image include a diffraction lobe associated with the second pitch from the first of the one or more illumination beams and a diffraction lobe associated with the first pitch from the second of the one or more illumination beams.

In embodiments, the techniques described herein relate to an overlay metrology system, where the one or more illumination beams are mutually coherent, where the two selected mutually coherent diffraction lobes associated with the first image include a diffraction lobe associated with the first pitch from both of the one or more illumination beams, where the two selected mutually coherent diffraction lobes associated with the second image include a diffraction lobe associated with the second pitch from both of the one or more illumination beams.

In embodiments, the techniques described herein relate to an overlay metrology system, where at least one of the first pitch, the second pitch, one or more wavelengths of the one or more illumination beams, or elements in the imaging sub-system are configured in accordance with the metrology recipe to provide that only the two selected mutually coherent diffraction lobes associated with the particular image are collected by the objective lens.

In embodiments, the techniques described herein relate to an overlay metrology system, where the imaging sub-system further includes one or more blockers to selectively pass the two selected mutually coherent diffraction lobes associated with the particular image to an associated one of the one or more detectors and selectively block light associated with other diffraction lobes.

In embodiments, the techniques described herein relate to an overlay metrology system, where the one or more images include a single image.

In embodiments, the techniques described herein relate to an overlay metrology system, where the one or more illumination beams include a single illumination beam, where the two selected mutually coherent diffraction lobes associated with the single image include diffraction lobes associated with diffraction of the single illumination beam.

In embodiments, the techniques described herein relate to an overlay metrology system, where the two selected mutually coherent diffraction lobes include a first double-diffraction lobe of a first of the one or more illumination beams by the overlapping grating structures and further include a second double-diffraction lobe of a second of the one or more illumination beams by the overlapping grating structures.

In embodiments, the techniques described herein relate to an overlay metrology system, where the imaging sub-system further includes one or more blockers to selectively pass the first double-diffraction lobe and the second double-diffraction lobe and selectively block light associated with other diffraction lobes.

In embodiments, the techniques described herein relate to an overlay metrology system, where the one or more blockers selectively block zero-order sidelobes associated with zero-order diffraction of the one or more illumination beams.

In embodiments, the techniques described herein relate to an overlay metrology system, where the one or more blockers selectively block first-order diffraction from the overlapping grating structures.

In embodiments, the techniques described herein relate to an overlay metrology system, where the overlay target in accordance with the metrology recipe includes one or more PQ cells including a first Moiré structure having the first pitch (P) on a first layer of a sample and the second pitch (Q) on a second layer of the sample; and one or more QP cells including a second Moiré structure having the second pitch on the first layer of the sample and the first pitch on the second layer of the sample.

In embodiments, the techniques described herein relate to an overlay metrology system including a controller including one or more processors configured to execute program instructions causing the one or more processors to implement a metrology recipe by generating one or more overlay measurements associated with one or more measurement directions based on one or more images of an overlay target from one or more detectors of an imaging sub-system, where the imaging sub-system generates the one or more images based on illumination with one or more illumination beams outside a numerical aperture of an objective lens used for imaging from opposing azimuth incidence angles rotated relative to the one or more measurement directions, where the overlay target in accordance with the metrology recipe includes one or more Moiré structures formed as overlapping grating structures with a first pitch and a second pitch, where a particular image of the one or more images is based exclusively on two selected mutually coherent diffraction lobes per measurement direction for at least one of the one or more measurement directions.

In embodiments, the techniques described herein relate to an overlay metrology system, where the one or more images include a first image and a second image, where the imaging sub-system includes a first imaging channel to form the first image and a second imaging channel to form the second image.

In embodiments, the techniques described herein relate to an overlay metrology system, where the two selected mutually coherent diffraction lobes associated with the first image include diffraction lobes associated with diffraction of a first of the one or more illumination beams at the first pitch and the second pitch, where the two selected mutually coherent diffraction lobes associated with the second image include diffraction lobes associated with diffraction of a second of the one or more illumination beams at the first pitch and the second pitch.

In embodiments, the techniques described herein relate to an overlay metrology system, where the one or more illumination beams have different wavelengths.

In embodiments, the techniques described herein relate to an overlay metrology system, where the one or more illumination beams have different polarizations.

In embodiments, the techniques described herein relate to an overlay metrology system, where the one or more illumination beams are mutually coherent, where the two selected mutually coherent diffraction lobes associated with the first image include a diffraction lobe associated with the first pitch from a first of the one or more illumination beams and a diffraction lobe associated with the second pitch from a second of the one or more illumination beams, where the two selected mutually coherent diffraction lobes associated with the second image include a diffraction lobe associated with the second pitch from the first of the one or more illumination beams and a diffraction lobe associated with the first pitch from the second of the one or more illumination beams.

In embodiments, the techniques described herein relate to an overlay metrology system, where the one or more illumination beams are mutually coherent, where the two selected mutually coherent diffraction lobes associated with the first image include a diffraction lobe associated with the first pitch from both of the one or more illumination beams, where the two selected mutually coherent diffraction lobes associated with the second image include a diffraction lobe associated with the second pitch from both of the one or more illumination beams.

In embodiments, the techniques described herein relate to an overlay metrology system, where at least one of the first pitch, the second pitch, one or more wavelengths of the one or more illumination beams, or elements in the imaging sub-system are configured in accordance with the metrology recipe to provide that only the two selected mutually coherent diffraction lobes associated with the particular image are collected by the objective lens.

In embodiments, the techniques described herein relate to an overlay metrology system, where the imaging sub-system further includes one or more blockers to selectively pass the two selected mutually coherent diffraction lobes associated with the particular image to an associated one of the one or more detectors and selectively block light associated with other diffraction lobes.

In embodiments, the techniques described herein relate to an overlay metrology system, where the one or more images include a single image.

In embodiments, the techniques described herein relate to an overlay metrology system, where the one or more illumination beams include a single illumination beam, where the two selected mutually coherent diffraction lobes associated with the single image include diffraction lobes associated with diffraction of the single illumination beam.

In embodiments, the techniques described herein relate to an overlay metrology system, where the two selected mutually coherent diffraction lobes include a first double-diffraction lobe of a first of the one or more illumination beams by the overlapping grating structures and further include a second double-diffraction lobe of a second of the one or more illumination beams by the overlapping grating structures.

In embodiments, the techniques described herein relate to an overlay metrology system, where the imaging sub-system further includes one or more blockers to selectively pass the first double-diffraction lobe and the second double-diffraction lobe and selectively block light associated with other diffraction lobes.

In embodiments, the techniques described herein relate to an overlay metrology system, where the one or more blockers selectively block zero-order sidelobes associated with zero-order diffraction of the one or more illumination beams.

In embodiments, the techniques described herein relate to an overlay metrology system, where the one or more blockers selectively block first-order diffraction from the overlapping grating structures.

In embodiments, the techniques described herein relate to an overlay metrology system, where the overlay target in accordance with the metrology recipe includes one or more PQ cells including a first Moiré structure having the first pitch (P) on a first layer of a sample and the second pitch (Q) on a second layer of the sample; and one or more QP cells including a second Moiré structure having the second pitch on the first layer of the sample and the first pitch on the second layer of the sample.

In embodiments, the techniques described herein relate to an overlay metrology method including illuminating an overlay target on a sample with one or more illumination beams outside a numerical aperture of an objective lens used for imaging from opposing azimuth incidence angles rotated relative to one or more measurement directions, where the overlay target in accordance with a metrology recipe includes one or more Moiré structures formed as overlapping grating structures with a first pitch and a second pitch; generating one or more images of the overlay target based on light collected by the objective lens, where a particular image of the one or more images is based exclusively on two selected mutually coherent diffraction lobes per measurement direction for at least one of the one or more measurement directions; and generating one or more overlay measurements associated with the one or more measurement directions based on the one or more images.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A is a conceptual view of an overlay metrology system, in accordance with one or more embodiments of the present disclosure.

FIG. 1B illustrates a simplified schematic view of an overlay metrology sub-system suitable for illuminating an overlay target with one or more pairs of illumination beams and imaging the overlay target based on a single non-zero diffraction lobe from each illumination beam, in accordance with one or more embodiments of the present disclosure.

FIG. 1C illustrates a simplified schematic of an overlay metrology sub-system including two collection channels, in accordance with one or more embodiments of the present disclosure.

FIG. 2A illustrates a top view of an overlay target, in accordance with one or more embodiments of the present disclosure.

FIG. 2B also illustrates a second Moiré structure having an upper grating with the second pitch (Q) on the first layer of the sample and a lower grating with the first pitch (P) on the second layer of the sample.

FIG. 3 illustrates a conceptual diagram of an illumination pupil providing a rotated pair of illumination beams overlaid with a collection pupil associated with a collection numerical aperture (NA), in accordance with one or more embodiments of the present disclosure.

FIG. 4 illustrates a first collection pupil configuration, in accordance with one or more embodiments of the present disclosure.

FIG. 5A illustrates a configuration for coherent dark-field imaging of an overlay target with Moiré structures in which images are generated with a P diffraction lobe and a Q diffraction lobe from a single illumination beam, in accordance with one or more embodiments of the present disclosure.

FIG. 5B illustrates an image of the overlay target from FIG. 2A with Moiré structures having periodicity along the X direction, where the image is generated based on splitting of the collection pupil as shown in FIG. 5A, in accordance with one or more embodiments of the present disclosure.

FIG. 6A illustrates a configuration for coherent dark-field imaging of an overlay target with Moiré structures in which images are generated with a P diffraction lobe from one illumination beam and a Q diffraction lobe another illumination beam in a mutually coherent pair, in accordance with one or more embodiments of the present disclosure.

FIG. 6B illustrates an image of the overlay target from FIG. 2A, but where the image is generated based on splitting of the collection pupil as shown in FIG. 6A, in accordance with one or more embodiments of the present disclosure.

FIG. 7A illustrates a configuration for coherent dark-field imaging of an overlay target with Moiré structures in which images are generated with P diffraction lobes and Q diffraction lobes from a mutually coherent pair of illumination beams, in accordance with one or more embodiments of the present disclosure.

FIG. 7B illustrates images of the overlay target from FIG. 2A, but where the image is generated based on splitting of the collection pupil as shown in FIG. 7A, in accordance with one or more embodiments of the present disclosure.

FIG. 8A illustrates a collection pupil configuration for coherent dark-field imaging of an overlay target with Moiré structures in which images are generated with a double-diffraction lobes, in accordance with one or more embodiments of the present disclosure.

FIG. 8B illustrates an image of an overlay target from FIG. 2A, but generated with the imaging configuration of FIG. 8A, in accordance with one or more embodiments of the present disclosure.

FIG. 8C illustrates an additional collection pupil configuration for coherent dark-field imaging of an overlay target with Moiré structures in which images are generated with a double-diffraction lobes, in accordance with one or more embodiments of the present disclosure.

FIG. 9 is a flow diagram illustrating steps performed in an overlay metrology method, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing overlay metrology by imaging an overlay target including one or more Moiré structures exclusively with two mutually coherent diffraction lobes. In this way, a portion of an image associated with a Moiré structure may include an interference pattern associated with the mutually coherent diffraction lobes. For example, a Moiré overlay target may include one or more Moiré structures, where a Moiré structure is formed as overlapping grating structures (e.g. grating-over-grating structures) with different pitch on different sample layers. As an illustration, a Moiré structure is described throughout as having a pitch P on one sample layer and a pitch Q on another sample layer. However, this is not a limitation. In some embodiments, an overlay target includes multiple Moiré structures including different pitches or combinations of pitches. For example, an overlay target may include one Moiré structure with pitches P and Q along with another Moiré structure with pitches S and T. Accordingly, examples provided herein describing an overlay target with a Moiré structure with pitches P and Q are merely illustrative and should not be interpreted as limiting the scope of the present disclosure.

It is contemplated herein that coherent dark-field imaging based on only two mutually coherent diffraction lobes, where the two mutually coherent diffraction lobes are associated with diffraction from the different pitches (e.g., P and Q, or the like) alone or through double diffraction, may provide high contrast imaging suitable for sensitive and robust measurements. Metrology based on mutually coherent oblique illumination is generally described in U.S. Pat. No. 12,032,300 issued on Jul. 9, 2024, and U.S. patent application Ser. No. 18/796,860 filed on Aug. 7, 2024; both of which are incorporated herein by reference in their entireties. In embodiments of the present disclosure, one or more illumination beams is directed to an overlay target with azimuth angles rotated relative to a direction of periodicity of Moiré structures (e.g., a measurement direction), which may provide spatial separation of diffraction lobes in a collection pupil plane. One or more images of the overlay target may then be generated based exclusively on two mutually coherent diffraction lobes (e.g., of the one or more illumination beams) per measurement direction. Mutually coherent diffraction lobes may be generated in any suitable manner providing that the mutually coherent diffraction lobes interfere (e.g., generate an interference pattern) that is detectable on an image. Depending on the configuration, mutually coherent diffraction lobes may be generated either from a single beam or from two mutually coherent illumination beams. Pupil splitting or blocking techniques may then be used to generate one or more images of the overlay target based on selected diffraction lobes. An overlay measurement may then be determined based on the one or more images.

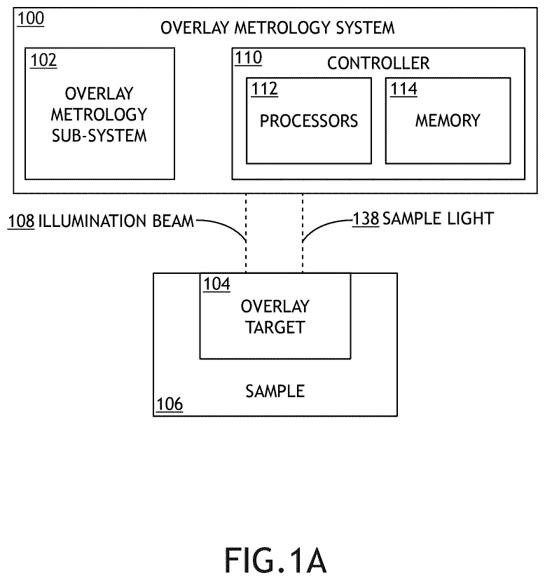

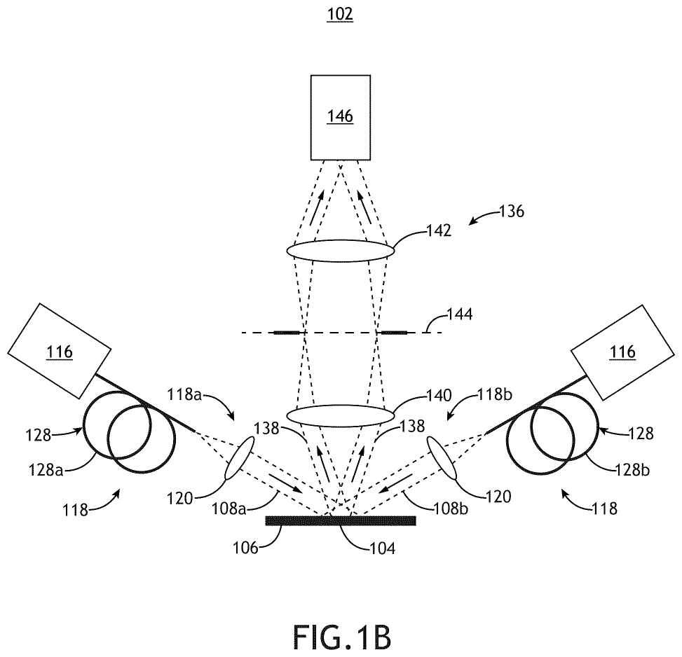

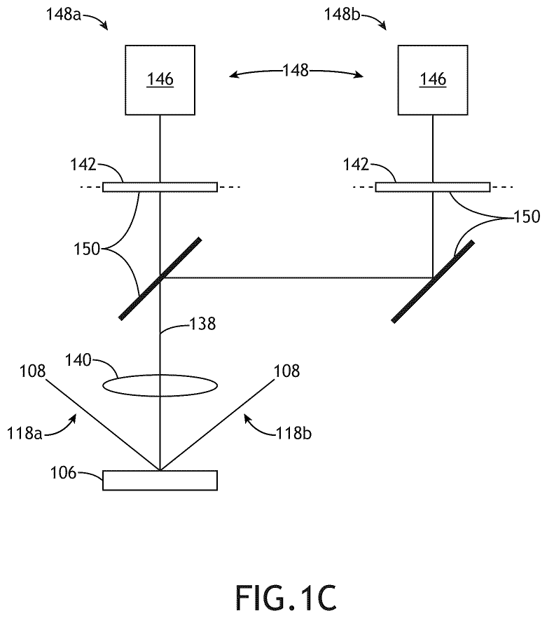

Referring now to FIGS. 1A-9, systems and methods providing overlay metrology based on coherent dark-field imaging with a rotated pair of mutually coherent illumination beams, in accordance with one or more embodiments of the present disclosure.

FIG. 1A is a conceptual view of an overlay metrology system 100, in accordance with one or more embodiments of the present disclosure.

In some embodiments, the overlay metrology system 100 includes an overlay metrology sub-system 102 configured to illuminate an overlay target 104 on a sample 106 with a pair of illumination beams 108 per measurement direction of interest. In particular, each of the illumination beams 108a,108b may fully illuminate the entirety of an overlay target 104. In this way, each cell of the overlay target 104 receives common illumination conditions to promote matched image brightness for all of the cells.

The overlay metrology sub-system 102 may generate one or more images of the overlay target 104, where each image is based on only two selected mutually coherent diffraction lobes. Put another way, each image may be generated based on interference of the two selected mutually coherent diffraction lobes. It is contemplated herein that selected diffraction lobes associated with different pitches of a Moiré structure either alone or based on double diffraction may enable high-contrast imaging. It is noted, however, that the use of the term image herein does not necessarily imply that all or even some portions of a Moiré structure within an overlay target are resolved (e.g., visually present) in an image. Rather, the resolvability of any features of the Moiré structure depends on the particular two mutually coherent diffraction lobes used to form the image. However, it is contemplated herein that generating an image based on interference of mutually coherent diffraction lobes associated with the different pitches of a Moiré structure either alone or based on double diffraction (e.g., interaction with grating structures having both the P and Q pitches) may provide data indicative of asymmetry between the associated sample layers such as, but not limited to, overlay data. In this way, an overlay measurement (or potentially other metrology measurements) may be generated based at least in part on the imaged Moiré structure. In some embodiments, an overlay measurement is generated based on multiple images of a particular Moiré structure (e.g., images generated with different selected diffraction lobes) and/or images of multiple Moiré structures (e.g., images generated of a PQ Moiré structure and a QP Moiré structure, images generated of a PQ Moiré structure and a ST Moiré structure, or the like).

In some embodiments, the overlay metrology system 100 includes a controller 110 communicatively coupled to the overlay metrology sub-system 102. The controller 110 may be configured to direct the overlay metrology sub-system 102 to generate dark-field images based on one or more selected metrology recipes. The controller 110 may be further configured to receive data including, but not limited to, dark-field images from the overlay metrology sub-system 102. Additionally, the controller 110 may be configured to determine overlay associated with an overlay target 104 based on the acquired dark-field images.

In some embodiments, the controller 110 includes one or more processors 112 configured to execute program instructions maintained in a memory 114, or memory device, where the program instructions may cause the processors 112 to implement various actions or steps disclosed herein.

The one or more processors 112 of a controller 110 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 112 may include any device configured to execute algorithms and/or instructions (e.g., program instructions stored in memory). In some embodiments, the one or more processors 112 may be embodied as a desktop computer, mainframe computer system, workstation, image computer, parallel processor, networked computer, or any other computer system configured to execute a program configured to operate or operate in conjunction with the measurement sub-systems 102, as described throughout the present disclosure. Moreover, different subsystems of the overlay metrology system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 110 may include one or more controllers housed in a common housing or within multiple housings. In this way, any controller or combination of controllers may be separately packaged as a module suitable for integration into overlay metrology system 100.

The memory 114 may include any storage medium known in the art suitable for storing program instructions executable by the associated one or more processors 112. For example, the memory 114 may include a non-transitory memory medium. By way of another example, the memory 114 may include, but is not limited to, a read-only memory (ROM), a random-access memory (RAM), a magnetic or optical memory device (e.g., disk), a magnetic tape, a solid-state drive and the like. It is further noted that the memory 114 may be housed in a common controller housing with the one or more processors 112. In some embodiments, the memory 114 may be located remotely with respect to the physical location of the one or more processors 112 and the controller 110. For instance, the one or more processors 112 of the controller 110 may access a remote memory (e.g., server), accessible through a network (e.g., internet, intranet and the like).

An overlay target 104 and/or an overlay metrology sub-system 102 suitable for characterizing the overlay target 104 may be configured to according to a metrology recipe suitable for generating overlay measurements based on a desired technique. More generally, an overlay metrology sub-system 102 may be configurable according to a variety of metrology recipes to perform overlay measurements using a variety of techniques and/or perform overlay measurements on a variety of overlay targets with different designs.

For example, a metrology recipe may include various aspects of an overlay target 104 or a design of an overlay target 104 including, but not limited to, a layout of target features on one or more sample layers, feature sizes, or feature pitches. As another example, a metrology recipe may include illumination parameters such as, but not limited to, an illumination wavelength, an illumination pupil distribution (e.g., a distribution of illumination angles and associated intensities of illumination at those angles), a polarization of incident illumination, a spatial distribution of illumination, or a sample height. By way of another example, a recipe of an overlay metrology tool may include collection parameters such as, but not limited to, a collection pupil distribution (e.g., a desired distribution of angular light from the sample to be used for a measurement and associated filtered intensities at those angles), collection field stop settings to select portions of the sample of interest, polarization of collected light, or wavelength filters.

As another example, the metrology recipe may include algorithmic steps associated with generating a metrology measurement (e.g., an overlay measurement, or the like) based on data from an overlay metrology sub-system 102. As an illustration, the metrology recipe may include processing steps associated with generating a metrology measurement from portions of one or more images of an overlay target 104.

FIG. 1B illustrates a simplified schematic view of an overlay metrology sub-system 102 suitable for illuminating an overlay target 104 with one or more pairs of illumination beams 108 and imaging the overlay target 104 based on a single non-zero diffraction lobe from each illumination beam 108, in accordance with one or more embodiments of the present disclosure.

In some embodiments, the overlay metrology sub-system 102 includes at least one illumination source 116 configured to generate the one or more pairs of illumination beams 108. Each illumination beam 108 may include one or more selected wavelengths of light including, but not limited to, ultraviolet (UV) radiation, visible radiation, or infrared (IR) radiation.

The illumination source 116 may include any type of illumination source suitable for providing at least one pair of illumination beams 108. In some embodiments, the illumination source 116 includes at least one laser source. For example, the illumination source 116 may include, but is not limited to, one or more narrowband laser sources, a broadband laser source, a supercontinuum laser source, a white light laser source, or the like. In this regard, the illumination source 116 may provide an illumination beam 108 having high coherence (e.g., high spatial coherence and/or temporal coherence). In some embodiments, the illumination beams within a pair are mutually coherent such that diffraction lobes from different illumination beams 108 may interfere.

In some embodiments, the overlay metrology sub-system 102 includes illumination optics to direct the various illumination beams 108 to an overlay target 104 on the sample 106 through one or more illumination channels 118. The sample 106 may be disposed on a sample stage (not shown) suitable for securing the sample 106 and further configured to position the overlay target 104 with respect to the illumination beams 108.

FIG. 1B illustrates the illumination of an overlay target 104 with a single pair of illumination beams 108 through two illumination channels (labeled as illumination channel 118a and illumination channel 118b). In some embodiments, the overlay metrology subsystem 102 illuminates an overlay target 104 with two pairs of illumination beams 108. In this configuration, the overlay metrology sub-system 102 may include an additional pair of illumination channels 118 oriented in a plane orthogonal to the FIG. 1B.

Further, an illumination channel 118 may provide an illumination beam 108 using any technique known in the art. For example, FIG. 1B depicts focusing the illumination beams 108 into optical fibers 128 (e.g., optical fiber 128a and optical fiber 128b) 128a, 128b which are also illustrated in FIG. 1B. An optical fiber 128a, 128b may be any type of optical fiber known in the art including, but not limited to, a single-mode fiber, a polarization-maintaining fiber, a single-mode polarization-maintaining fiber, a multi-mode fiber, or the like. However, it is to be understood that the illumination beams 108 may be delivered to the overlay target 104 using any suitable optical elements including, but not limited to, free-space optical elements.

Each of the illumination channels 118 may include one or more optical components suitable for modifying and/or conditioning an illumination beam 108 as well as directing the illumination beam 108 to the overlay target 104. For example, each of the illumination channels 118 may include, but is not required to include, one or more illumination lenses 120 (e.g., to control a spot size of the illumination beam 108 on the overlay target 104, to relay pupil and/or field planes, or the like), one or more polarizers to adjust the polarization of the illumination beam 108 in the channel, one or more filters, one or more beam splitters, one or more diffusers, one or more homogenizers, one or more apodizers, one or more beam shapers, or one or more mirrors (e.g., static mirrors, translatable mirrors, scanning mirrors, or the like).

In some embodiments, as illustrated in FIG. 1B, the illumination channels 118 direct the illumination beams 108 to the sample 106 at polar incidence angles outside a NA of the objective lens 140, which may be referred to as an outside-the-lens (OTL) configuration.

In some embodiments, the overlay metrology sub-system 102 includes imaging optics within a collection pathway 136 for the collection of light from the overlay target 104 (e.g., sample light 138). In some embodiments, the collection pathway 136 includes an objective lens 140 to collect diffracted or scattered light from the overlay target 104. For example, the objective lens 140 may collect one or more diffracted orders of radiation from the overlay target 104 in response to the illumination beams 108.

In some embodiments, the collection pathway 136 includes at least one detector 146 configured to generate an image (e.g., a dark-field image) of the overlay target 104. For example, a detector 146 may receive an image of the sample 106 provided by elements in the collection pathway 136 (e.g., the objective lens 140, the one or more lenses 142, or the like). For example, FIG. 1B illustrates generating a dark-field image of an overlay target 104 with a single non-zero diffraction lobe from each illumination beam 108 of a pair of illumination beams 108. However, as described throughout the present disclosure, this is merely an illustration and not limiting on the scope of the present disclosure.

In some embodiments, the overlay metrology sub-system 102 includes two or more detectors 146. For example, the overlay metrology sub-system 102 may include two or more collection channels, each with a separate detector. In this way, the overlay metrology sub-system 102 may simultaneously generate multiple images based on different selected diffraction lobes.

The collection pathway 136 may further include multiple optical elements to manipulate light collected by the objective lens 140 including, but not limited to one or more lenses 142, one or more filters, one or more polarizers, one or more beam blocks, or one or more beamsplitters. Such elements may be located in any suitable location in the collection pathway 136 including, but not limited to, a collection pupil 144.

FIG. 1C illustrates a simplified schematic of an overlay metrology sub-system 102 including two collection channels 148 (collection channel 148a and collection channel 148b), in accordance with one or more embodiments of the present disclosure. FIG. 1C omits various components shown in FIG. 1B for clarity. In some embodiments, the collection pathway 136 includes one or more channel-splitting optical elements 150 configured to split collected light into the various channels. The one or more channel-splitting optical elements 150 may include any type or combination of components suitable for directing selected diffraction lobes to an associated detector 146 such as, but not limited to, polarizing beamsplitters, non-polarizing beamsplitters, wavelength-selective beamsplitters, or apertures in a collection pupil 144.

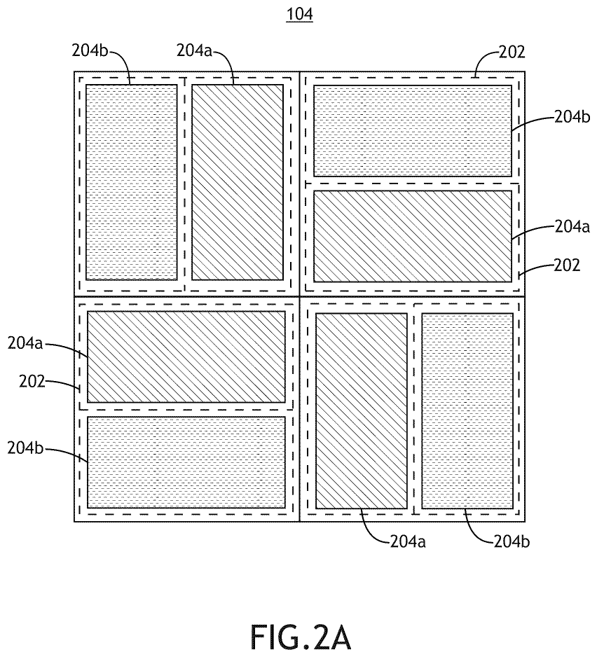

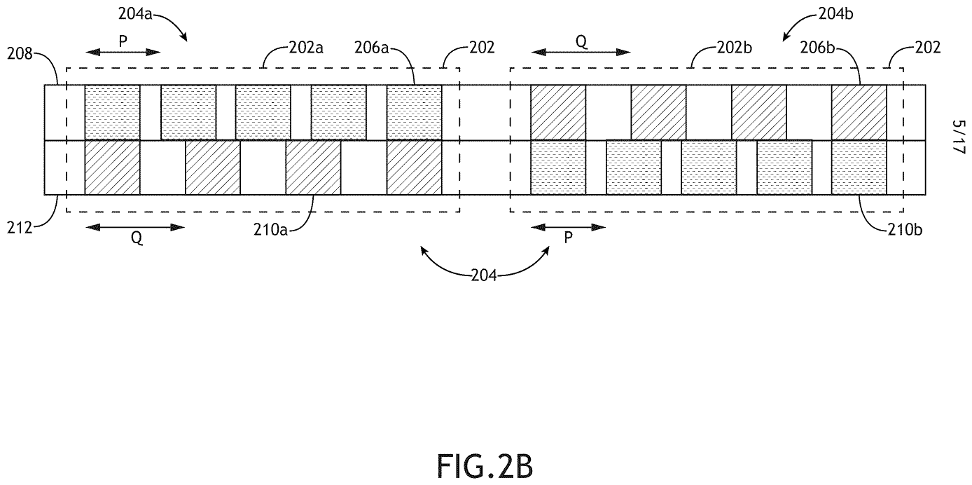

Referring now to FIGS. 2A-8C, various configurations for overlay metrology based on coherent dark-field imaging of Moiré structures on an overlay target 104 are described, in accordance with one or more embodiments of the present disclosure.

FIGS. 2A and 2B illustrate an overlay target 104, in accordance with one or more embodiments of the present disclosure. FIG. 2A illustrates a top view of an overlay target 104, in accordance with one or more embodiments of the present disclosure. FIG. 2B illustrates a side view of two adjacent cells 202 (labeled as cell 202a and cell 202b) including Moiré structures 204 that may form a quadrant of an overlay target 104 as depicted in FIG. 2A, in accordance with one or more embodiments of the present disclosure.

A Moiré structure 204 may include two gratings in overlapping regions of the sample 106, where the two gratings have different pitches (e.g., P and Q). For example, FIG. 2B illustrates a first Moiré structure 204a having an upper grating 206a with a first pitch (P) on a first layer 208 of the sample 106 and a lower grating 210a with a second pitch (Q) on a second layer 212 of the sample 106 (e.g., a PQ Moiré structure).

In some embodiments, an overlay target 104 includes multiple Moiré structures 204. For example, FIG. 2A depicts a configuration of an overlay target 104 with two first Moiré structures 204a oriented with periodicity along orthogonal measurement directions along with two second Moiré structures 204b also oriented with periodicity along orthogonal measurement directions. Such a configuration may facilitate overlay measurements along the orthogonal directions though any technique including, but not limited to, comparing a center of symmetry of the first Moiré structures 204a (e.g., in one or more images as disclosed herein) with a center of symmetry of the second Moiré structures 204b (e.g., in one or more images as disclosed herein).

In some embodiments, an overlay target 104 includes complementary Moiré structures 204 having opposite pitches in the corresponding layers. For example, FIG. 2B illustrates a second Moiré structure 204b having an upper grating 206b with the second pitch (Q) on the first layer 208 of the sample 106 and a lower grating 210b with the first pitch (P) on the second layer 212 of the sample 106 (e.g., a QP Moiré structure). Such a configuration may be useful to provide self-referencing and/or self-calibration when generating an overlay measurement. For example, a physical overlay error (e.g., an unintended misregistration between sample layers forming the overlay target 104) may cause interference fringes in imaged portions of complementary Moiré structures to move in opposite directions relative to a nominal state. However, this is not a requirement. In some embodiments, the overlay target 104 may include at least one second Moiré structure 204b with one or more pitches that differ from the first Moiré structure. For example, the second Moiré structures 204b may include ST Moiré structures with pitches S and T. As another example, the second Moiré structures 204b may include PR Moiré structures with pitches P and R.

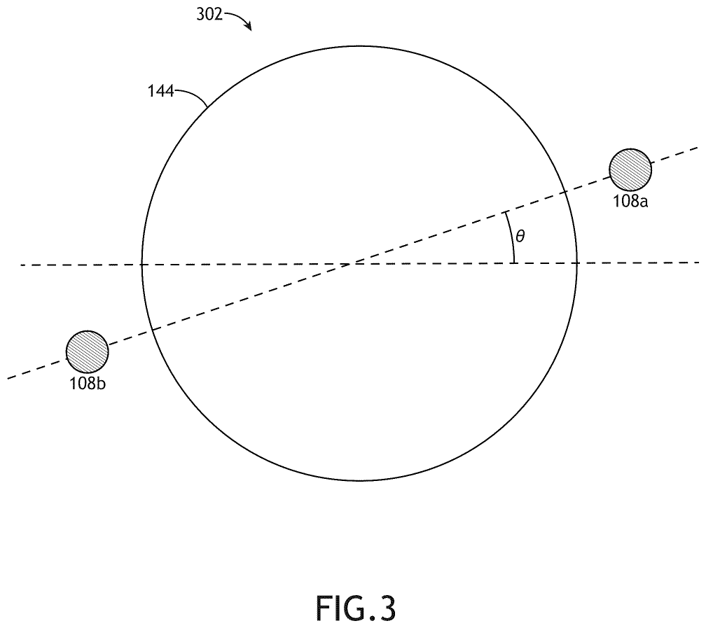

FIGS. 3-8C depict various non-limiting configurations for coherent dark-field imaging of Moiré structures 204 in an overlay target 104, in accordance with one or more embodiments of the present disclosure.

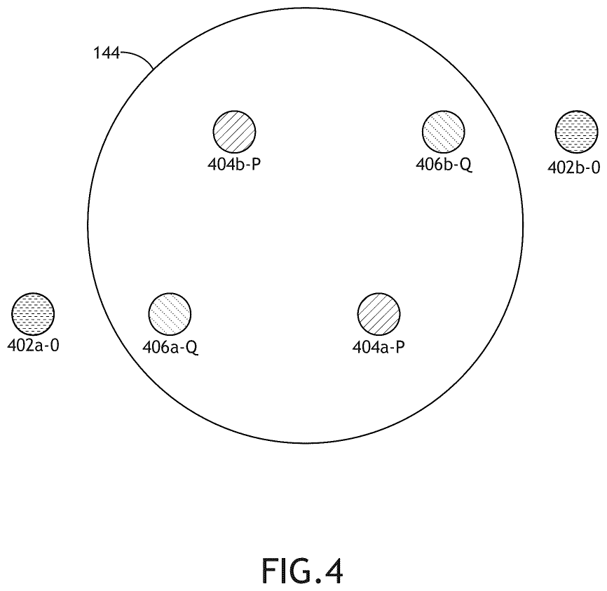

FIG. 3 illustrates a conceptual diagram of an illumination pupil 302 providing a rotated pair of illumination beams 108 (labeled as 108a and 108b) overlaid with a collection pupil 144 associated with a collection NA (e.g., associated with the objective lens 140), in accordance with one or more embodiments of the present disclosure. In particular, FIG. 3 depicts an OTL imaging configuration with two illumination beams 108 having incidence angles outside the collection pupil 144, which corresponds to the configuration shown in FIGS. 1B-1C. Further, the illumination beams 108a,108b are oriented in a rotated dipole configuration with an angle θ relative to a horizontal direction in the figure. As will be shown in FIGS. 4-8C below, a rotated dipole configuration may spatially separate diffraction lobes associated with diffraction of the illumination beams 108 within the collection pupil 144, which may enable certain diffraction lobes to be selected (e.g., isolated) for generation of a particular image. For example, the particular angle θ in FIG. 3 may provide vertical separation of diffraction lobes along the X direction (e.g., from Moiré structures 204 with periodicity along the X direction). In this way, the configuration in FIG. 3 may be suitable for overlay measurements of targets having periodicity along the X direction.

Although not shown, the overlay metrology sub-system 102 may provide multiple pairs of illumination beams 108. For example, the overlay metrology sub-system 102 may provide an additional rotated pair of illumination beams 108 at a rotation angle orthogonal the angle θ, which may be suitable for overlay measurements of targets having periodicity along the Y direction. In some embodiments, it may be the case that a single rotated dipole provides sufficient separation of diffraction lobes along the X and Y directions such that a single pair of mutually coherent illumination beams may be suitable for imaging Moiré structures having periodicities along the X or Y directions. Further, it is to be understood that any combination of the illumination beams 108 may be mutually coherent such that diffraction lobes from these illumination beams 108 may interfere on a detector 146. However, mutual coherence of any particular illumination beams 108 is not required so long as any particular image generated by the overlay metrology sub-system 102 is formed from two selected mutually coherent diffraction lobes. Additionally, in some embodiments, two mutually coherent diffraction beams may

be generated using a single illumination beam with an azimuth angle rotated relative to the measurement directions of interest. In this way, only a single one of the illumination beams 108 from FIG. 3 (e.g., illumination beam 108a or illumination beam 108b) may be sufficient in some applications.

FIGS. 4-7B depict configurations for generating coherent dark-field images of Moiré structures using selected P and Q diffraction lobes, in accordance with one or more embodiments of the present disclosure. In particular, FIGS. 4-7B depict techniques for isolating selected P and Q lobes in a collection pupil 144 for imaging. However, this is merely illustrative and should not be interpreted as limiting on the scope of the present disclosure.

FIG. 4 illustrates a first collection pupil 144 configuration, in accordance with one or more embodiments of the present disclosure. FIG. 4 depicts three diffraction lobes associated with diffraction of the first illumination beam 108a from FIG. 3: a zero-order diffraction lobe 402a-0, a P diffraction lobe 404a-P, and a Q diffraction lobe 406a-Q. FIG. 4 also depicts three diffraction lobes associated with diffraction of the second illumination beam 108b from FIG. 3: a zero-order diffraction lobe 402b-0, a P diffraction lobe 404b-P, and a Q diffraction lobe 406b-Q. It is noted that FIG. 4 depicts a particular configuration in with the P diffraction lobes 404a-P,404b-P as well as the Q diffraction lobes 406a-Q,404b-Q correspond to first-order diffraction by features with the respective pitches. However, this is merely an illustration and the P diffraction lobes 404a-P,404b-P as well as the Q diffraction lobes 406a-Q,404b-Q may generally be associated with any order of diffraction by features with the respective pitches such as, but not limited to, first-order diffraction, second-order diffraction, or the like.

As illustrated in FIG. 4, the OTL imaging configuration results in the zero-order diffraction lobes 402a-0,402b-0 falling outside the NA of the objective lens 140 and thus a dark-field imaging condition. Further, the various P diffraction lobes 404a-P,404b-P and Q diffraction lobes 406a-Q,406b-Q are spatially spread in the collection pupil 144. As a result, images may be formed from any selected pairs of diffraction lobes by blocking remaining diffraction lobes.

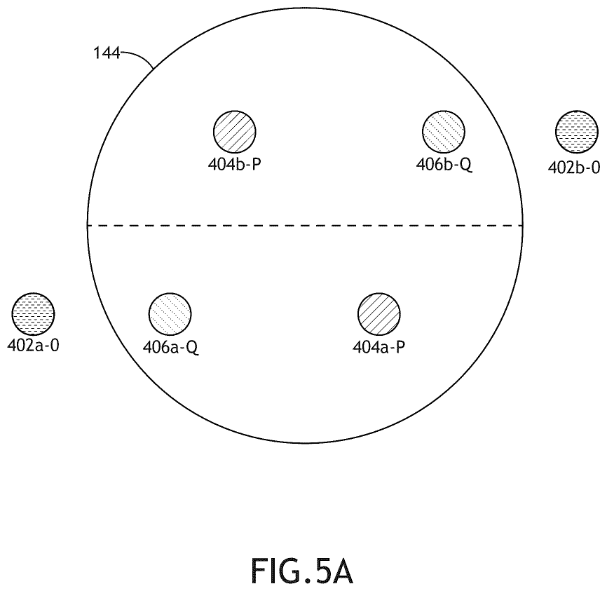

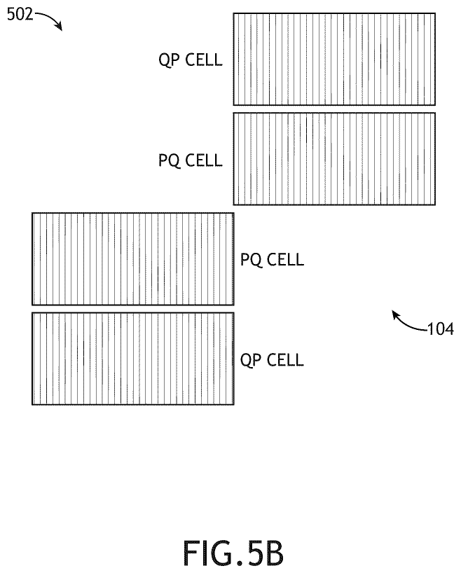

FIG. 5A illustrates a configuration for coherent dark-field imaging of an overlay target 104 with Moiré structures 204 in which images are generated with a P diffraction lobe and a Q diffraction lobe from a single illumination beam 108, in accordance with one or more embodiments of the present disclosure. In some embodiments, the collection pupil 144 of FIG. 4 is split such that the P diffraction lobe 404a-P and the Q diffraction lobe 406a-Q from the first illumination beam 108a are directed to a first detector 146 (e.g., in one collection channel 148), and the P diffraction lobe 404b-P and the Q diffraction lobe 406b-Q from the second illumination beam 108b are directed to a second detector 146 (e.g., in one collection channel 148). In this configuration, the two illumination beams 108a,108b depicted in FIG. 5A need not be mutually coherent since the P and Q diffraction lobes associated with any particular illumination beam 108 (e.g., illumination beam 108a or illumination beam 108b are mutually coherent). In some embodiments, only one illumination beam (e.g., illumination beam 108a or illumination beam 108b) is captured and used for generating an overlay measurement. However, it may be the case that generating an overlay measurement based on two images associated with both illumination beams 108a,108b may provide a more robust measurement in the case of illumination asymmetry.

FIG. 5B illustrates an image 502 of the overlay target 104 from FIG. 2A with Moiré structures having periodicity along the X direction, where the image 502 is generated based on splitting of the collection pupil 144 as shown in FIG. 5A, in accordance with one or more embodiments of the present disclosure. For example, the overlay target 104 imaged in FIG. 5B may have complementary PQ and QP Moiré structures as shown in FIG. 2A. Further, the image 502 in FIG. 5B may be representative of an image generated with mutually coherent diffraction lobes from either illumination beam 108 shown in FIG. 5A (e.g., illumination beam 108a or illumination beam 108b). For example, the image 502 in FIG. 5B may be generated based on either the P diffraction lobe 404a-P and Q diffraction lobe 406a-Q from the first illumination beam 108a or from the P diffraction lobe 404b-P and Q diffraction lobe 406b-Q from the second illumination beam 108b.

It is noted that the interference fringes shown in FIG. 5B may not correspond to physical features on the sample, but may rather correspond to an interference pattern between the selected P and Q diffraction lobes. For example, the interference fringes observed in the image in FIG. 5B may depend on the factors such as the values of pitches P and Q, as well as the separation distance of the associated lobes in the collection pupil 144. However, the positions of the fringes may be indicative of overlay such that an overlay measurement may be generated from images generated by one or both halves of the collection pupil 144 shown in FIG. 5A. For example, an overlay measurement may be generated by comparing fringe positions of the PQ cells relative to the QP cells in one or more images.

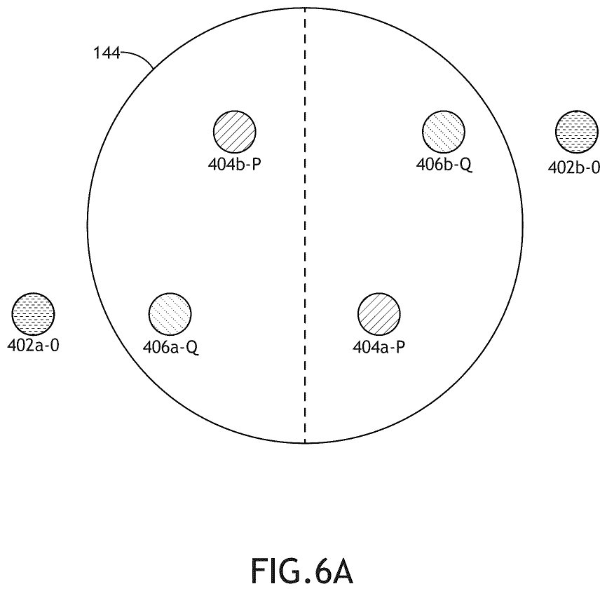

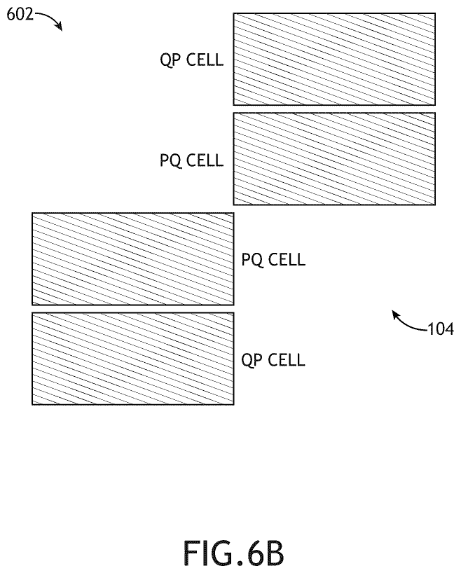

FIG. 6A illustrates a configuration for coherent dark-field imaging of an overlay target 104 with Moiré structures 204 in which images are generated with a P diffraction lobe from one illumination beam and a Q diffraction lobe another illumination beam in a mutually coherent pair, in accordance with one or more embodiments of the present disclosure. In some embodiments, the collection pupil 144 of FIG. 4 is split such that the P diffraction lobe 404a-P from the first illumination beam 108a and the Q diffraction lobe 406b-Q from the second illumination beam 108b are directed to a first detector 146, and the P diffraction lobe 404b-P from the second illumination beam 108b and the Q diffraction lobe 406a-Q from the first illumination beam 108a are directed to a second detector 146.

FIG. 6B illustrates an image 602 of the overlay target 104 from FIG. 2A, but where the image is generated based on splitting of the collection pupil 144 as shown in FIG. 6A, in accordance with one or more embodiments of the present disclosure. The image 602 may be representative of an image generated with mutually coherent diffraction lobes from either portion of the collection pupil 144 shown in FIG. 6A. For example, the image 502 in FIG. 6B may be generated based on either the P diffraction lobe 404a-P and the Q diffraction lobe 406b-Q or based on the P diffraction lobe 404b-P and the Q diffraction lobe 406a-Q.

As with FIG. 5B, the interference fringes shown in FIG. 6B may not correspond to physical features on the sample, but may rather correspond to an interference pattern between the selected P or Q diffraction lobes. For example, the interference fringes observed in the image in FIG. 6B may depend on the factors such as the values of pitches (P or Q), as well as the separation distance of the associated lobes in the collection pupil 144. However, the positions of the fringes may be indicative of overlay such that an overlay measurement may be generated from images generated by one or both halves of the collection pupil 144 shown in FIG. 6A. For example, an overlay measurement may be generated by comparing fringe positions of the PQ cells relative to the QP cells in one or more images.

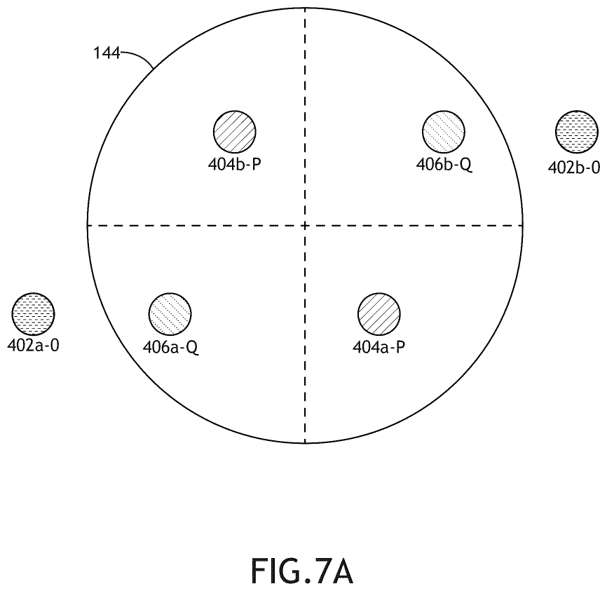

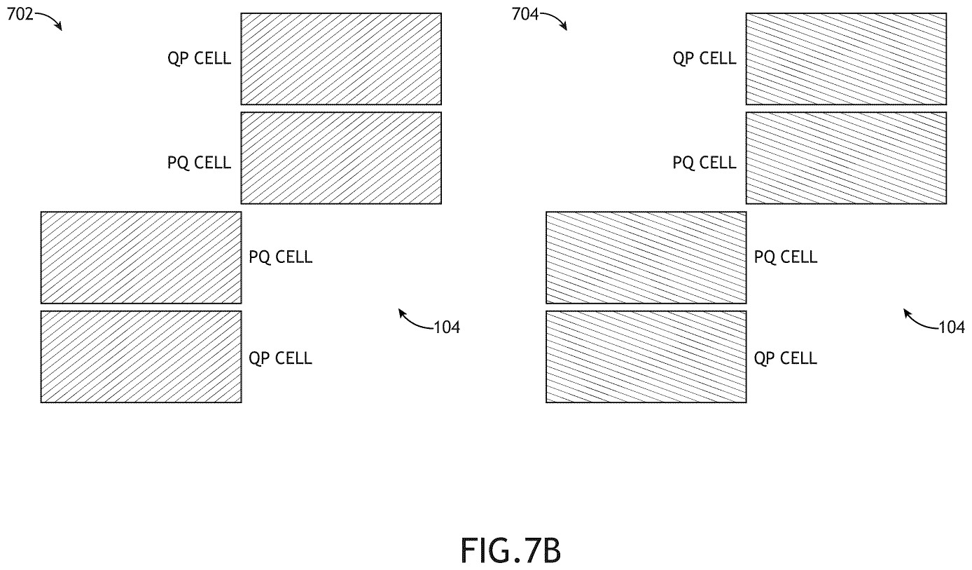

FIG. 7A illustrates a configuration for coherent dark-field imaging of an overlay target 104 with Moiré structures 204 in which images are generated with P diffraction lobes and Q diffraction lobes from a mutually coherent pair of illumination beams, in accordance with one or more embodiments of the present disclosure. In some embodiments, the collection pupil 144 of FIG. 4 is split such that the P diffraction lobes 404a-P,404b-P in opposing quadrants of the collection pupil 144 are directed to a first detector 146, while the Q diffraction lobes 406a-Q,406b-Q are directed to a second detector 146.

FIG. 7B illustrates images 702,704 of the overlay target 104 from FIG. 2A, but where the image is generated based on splitting of the collection pupil 144 as shown in FIG. 7A, in accordance with one or more embodiments of the present disclosure. In particular, image 702 may be generated based on interference of the P diffraction lobes 404a-P,404b-P, while image 704 may be generated based on interference of the Q diffraction lobes 406a-Q,406b-Q.

As with FIGS. 5B and 6B, the interference fringes shown in the images 702,704 in FIG. 7B may not correspond to physical features on the sample, but may rather correspond to an interference pattern between the selected P and Q diffraction lobes. For example, the interference fringes observed in the image in FIG. 7B may depend on the factors such as the values of pitches (P and Q), as well as the separation distance of the associated lobes in the collection pupil 144. However, the positions of the fringes may be indicative of overlay such that an overlay measurement may be generated from images generated by one or both halves of the collection pupil 144 shown in FIG. 7A. For example, an overlay measurement may be generated by comparing fringe positions of the PQ cells relative to the QP cells in one or more images.

Referring generally to FIGS. 4-7B, this configuration may provide both a reduction in move and measure (MAM) acquisition time as well as precision relative to existing techniques (e.g., generation of an image based on all four diffraction lobes present in FIG. 4). For example, imaging with two selected diffraction lobes from mutually coherent illumination beams 108 may provide balanced contrast between the complementary PQ and QP Moiré structures, which may promote sensitive and robust measurements. Further, this configuration provides flexibility for selecting an observed image pitch (e.g., an observed pitch in a portion of an image associated with a Moiré structure that depends on the particular selection of two diffraction lobes) for different wavelengths of the illumination beams 108. In this way, the wavelength may be flexibly selected and may not constrain the formed image pitch.

The configuration depicted in FIGS. 4-7B may be extended to provide simultaneous imaging with different wavelengths and/or polarizations of the illumination beams 108. For example, the configuration shown in FIGS. 5A-5B may be implemented with different wavelengths for the two illumination beams 108a,108b. In these cases, the channel-splitting optical elements may include, but are not required to include, wavelength-selective elements. This may have the benefit of providing simultaneous measurements at different wavelengths without a throughput penalty. As another example, any of the configurations, shown in FIGS. 5A-7B may be implemented with different polarizations of the two illumination beams 108a,108b. In these cases, the channel-splitting optical elements may include, but are not required to include, polarization-selective elements.

Additionally, although the configurations depicted in FIGS. 4-7B only depict four collected diffraction lobes (e.g., P and Q diffraction lobes associated with two illumination beams 108), this is merely an illustration and should not be interpreted as limiting the scope of the present disclosure. In some embodiments, the overlay metrology sub-system 102 includes one or more elements in a collection pathway 136 to block unwanted signals from reaching a detector 146. For example, the overlay metrology sub-system 102 may include blockers in a collection pupil 144 to block unwanted signals such as, but not limited to, unwanted diffraction lobes or unwanted diffraction sidelobes.

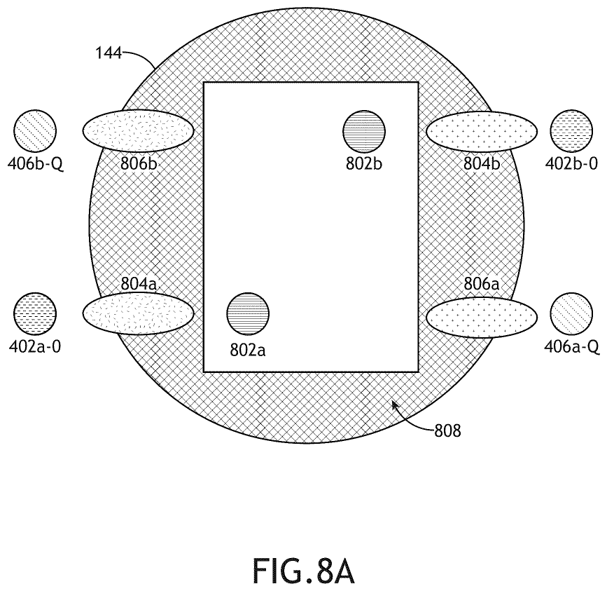

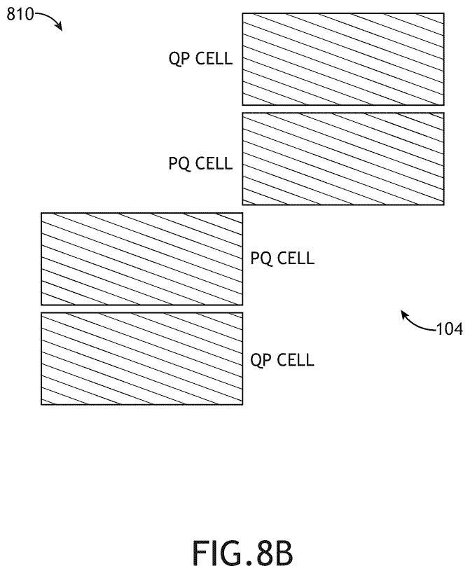

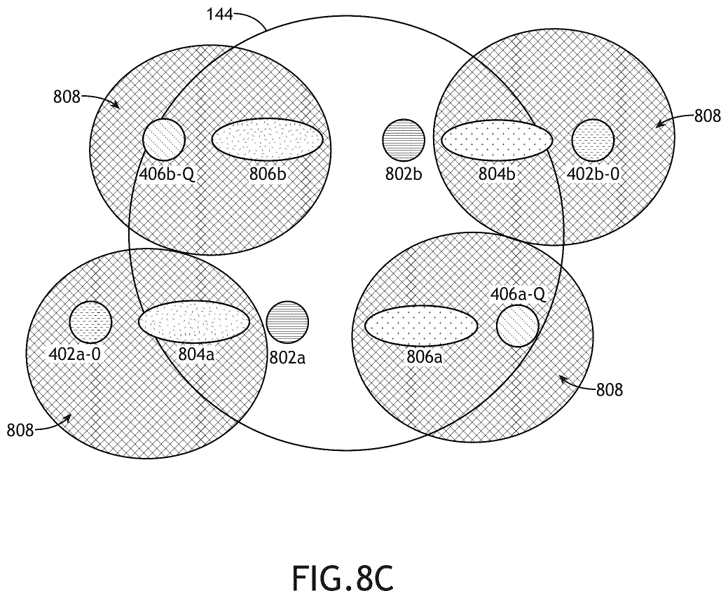

Referring now to FIGS. 8A-8C, configurations for generating coherent dark-field images of Moiré structures using double diffraction lobes are described, in accordance with one or more embodiments of the present disclosure.

FIG. 8A illustrates a collection pupil 144 configuration for coherent dark-field imaging of an overlay target 104 with Moiré structures 204 in which images are generated with a double-diffraction lobes, in accordance with one or more embodiments of the present disclosure. As described with respect to FIG. 4, an OTL configuration provides that zero-order diffraction lobes 402a-0,402b-0 fall outside the collection NA of the objective lens 140 and thus fall outside the collection pupil 144.

FIG. 8A further depicts double diffraction lobes (double-diffraction lobe 802a and double diffraction lobe 802b) associated with illumination beams 108a,108b, respectively, where the illumination beams 108a,108b are mutually coherent. It is contemplated herein that a diffraction angle associated with a double-diffraction lobe (e.g., a diffraction lobe associated with diffraction from grating structures on both layers of a Moiré structure 204) may be lower than P or Q diffraction lobes. As a result, the configuration depicted in FIG. 8A may enable the use of lower pitch values and/or different wavelength ranges than the configuration in FIG. 4 to provide separation between the double-diffraction lobes 802a,802b and the respective zero-order diffraction lobes 402a-0,402b-0. For example, FIG. 8A depicts a configuration in which the Q diffraction lobes 406a-Q,406b-Q are also outside the collection pupil 144 and the P diffraction lobes 404a-P,404b-P are not shown. In a general sense, the P and Q diffraction lobes may be outside the collection pupil 144, non-propagating, or blocked.

In some embodiments, the double-diffraction lobes 802a,802b are propagated to a detector 146 for imaging. FIG. 8B illustrates an image 810 of an overlay target 104 from FIG. 2A, but generated with the imaging configuration of FIG. 8A, in accordance with one or more embodiments of the present disclosure. As shown in FIG. 8B, portions of the image associated with the Moiré structures 204 include an interference pattern associated with interference of the double-diffraction lobes 802a,802b. An overlay measurement may then be generated based on a comparison of the interference patterns of the PQ Moiré structures relative to the QP Moiré structures.

Referring again to FIG. 8A, it may be the case that finite target size effects associated with a relatively small overlay target 104 may result in substantial sidelobes such as, but not limited to, zero-order sidelobes (here, zero-order sidelobe 804a and zero-order sidelobe 804b) or first-order sidelobes (here, first-order sidelobe 806a and first-order sidelobe 806b). Accordingly, the overlay metrology sub-system 102 may include one or more blockers 808 (e.g., in a collection pupil 144) to block the various sidelobes as well as any additional unwanted signals. For example, FIG. 8A depicts a blocker 808 providing a square aperture to pass the double-diffraction lobes 802a,802b while blocking the zero-order sidelobes 804a,804b and first-order sidelobes 806a,806b.

FIG. 8C illustrates an additional collection pupil 144 configuration for coherent dark-field imaging of an overlay target 104 with Moiré structures 204 in which images are generated with a double-diffraction lobes, in accordance with one or more embodiments of the present disclosure. The requirements for the pitches P and Q of the Moiré structures 204 may be relaxed relative to the configuration in FIG. 8A.

For example, FIG. 8C depicts a configuration in which the Q diffraction lobes 406a-Q,406b-Q fall within the collection pupil 144 and the zero-order sidelobes 804a,804b extend further into the collection pupil 144 than shown in FIG. 8A. In this configuration, the square aperture as shown in FIG. 8A may not blockers 808 may not simultaneously pass the double-diffraction lobes 802a,802b while blocking the sidelobes. Accordingly, FIG. 8C depicts a configuration with multiple blockers 808 arranged to pass the double-diffraction lobes 802a,802b while blocking the zero-order sidelobes 804a,804b and the first-order sidelobes 806a,806b. However, the particular number and shape of the blockers 808 depicted in FIG. 8C is merely illustrative and not limiting on the scope of the present disclosure. Rather, any number of blockers 808 in any configuration may be used to block unwanted signals.

Further, it is to be understood that FIGS. 4-8C and the associated descriptions are merely illustrative and not limiting on the scope of the present disclosure.

For example, it is not a requirement that only two mutually coherent diffraction lobes are passed to a detector 146 to generate an image. In some embodiments, signal processing techniques such as, but not limited to, Fourier filtering are utilized to algorithmically filter out unwanted signals. As an illustration in the context of FIGS. 8A-8C, signal processing techniques may be used to filter out signals associated with unwanted P and/or Q diffraction lobes that may pass to the detector 146. In this way, it may be possible to generate an image exclusively with two mutually coherent illumination beams even if additional unwanted signals are present at the detector 146.

As another example, FIGS. 3-8C focus on illumination and collection configurations suitable for coherent dark-field imaging of Moiré structures having periodicity along the X direction in the various figures. However, as depicted in FIG. 2A, an overlay target 104 may include Moiré structures 204 with periodicities along multiple directions. It is to be understood that the descriptions of FIGS. 3-8C may be extended to provide imaging and associated overlay measurements based for Moiré structures 204 in an overlay target 104 having periodicities along another direction (e.g., the Y direction). In some cases, images associated with Moiré structures with periodicities along different directions are imaged on common detectors 146 (e.g., with pairs of illumination beams 108) that are incoherent with respect to each other). In some cases, images associated with Moiré structures with periodicities along different directions are imaged on different detectors 146 in different collection channels 148.

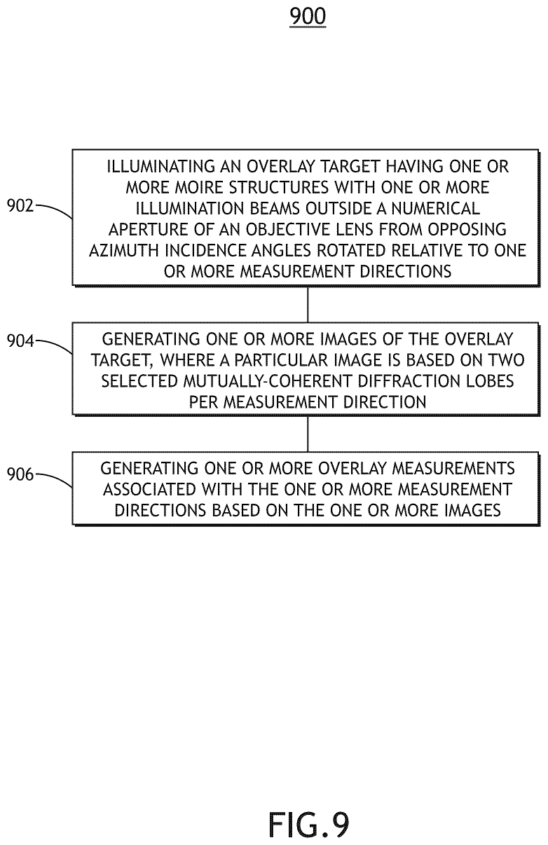

FIG. 9 is a flow diagram illustrating steps performed in an overlay metrology method 900, in accordance with one or more embodiments of the present disclosure. The embodiments and enabling technologies described previously herein in the context of the overlay metrology system 100 should be interpreted to extend to the method 900. For example, the processors 112 of the controller 110 may execute program instructions causing the processors 112 to implement one or more steps of the method 900 either directly (e.g., algorithmically) or indirectly by generating control signals to control other components in the overlay metrology system 100 or external to the overlay metrology system 100. However, that the method 900 is not limited to the architecture of the overlay metrology system 100.

The method 900 may include a step 902 of illuminating an overlay target on a sample with two illumination beams outside a numerical aperture of an objective lens used for imaging from opposing azimuth incidence angles rotated relative to one or more measurement directions, where the overlay target in accordance with a metrology recipe includes one or more Moiré structures formed as overlapping grating structures with a first pitch (P) and a second pitch (Q).

The method 900 may include a step 904 of generating one or more images of the overlay target based on light collected by the objective lens, where a particular image of the one or more images is based on two selected mutually coherent diffraction lobes per measurement direction for at least one of the one or more measurement directions. For example, the two selected mutually coherent diffraction lobes used to generate an image associated with any particular measurement direction may correspond to any combination of P diffraction lobes, Q diffraction lobes, or double-diffraction lobes so long as they are mutually coherent and may thus interfere when generating an image.

The method 900 may include a step 906 of generating one or more overlay measurements associated with the one or more measurement directions based on the one or more images.

In some embodiments, the method 900 further includes a step of generating correctables for one or more process tools based on the one or more overlay measurements. For example, the correctables based on one or more metrology measurements may be used to control a fabrication tool using any combination of feed-forward or feedback control techniques. As an illustration, feedback control may be used to compensate for deviations of a fabrication tool for various samples within a lot or series of lots. As another illustration, feed-forward control may be used to compensate for deviations measured at one process step for a sample or series of samples when performing a subsequent process step. Any type of fabrication tool may be controlled such as, but not limited to, a lithography tool (e.g., a scanner, a stepper, or the like), an etching tool, or a polishing tool.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An overlay metrology system comprising:
an illumination source configured to generate one or more illumination beams;
an objective lens;
an illumination sub-system including one or more illumination lenses to illuminate an overlay target with the one or more illumination beams outside a numerical aperture of the objective lens from opposing azimuth incidence angles rotated relative to one or more measurement directions, wherein the overlay target in accordance with a metrology recipe includes one or more Moiré structures formed as overlapping grating structures with a first pitch and a second pitch;
an imaging sub-system including one or more detectors configured to generate one or more images of the overlay target based on light collected by the objective lens, wherein a particular image of the one or more images is based exclusively on two selected mutually coherent diffraction lobes per measurement direction for at least one of the one or more measurement directions; and
a controller including one or more processors configured to execute program instructions causing the one or more processors to generate one or more overlay measurements associated with the one or more measurement directions based on the one or more images.

2. The overlay metrology system of claim 1, wherein the one or more images comprise a first image and a second image, wherein the imaging sub-system includes a first imaging channel to form the first image and a second imaging channel to form the second image.

3. The overlay metrology system of claim 2, wherein the two selected mutually coherent diffraction lobes associated with the first image comprise diffraction lobes associated with diffraction of a first of the one or more illumination beams at the first pitch and the second pitch, wherein the two selected mutually coherent diffraction lobes associated with the second image comprise diffraction lobes associated with diffraction of a second of the one or more illumination beams at the first pitch and the second pitch.

4. The overlay metrology system of claim 3, wherein the first of the one or more illumination beams and the second of the one or more illumination beams have different wavelengths.

5. The overlay metrology system of claim 3, wherein the first of the one or more illumination beams and the second of the one or more illumination beams have different polarizations.

6. The overlay metrology system of claim 2, wherein the one or more illumination beams are mutually coherent, wherein the two selected mutually coherent diffraction lobes associated with the first image comprise a diffraction lobe associated with the first pitch from a first of the one or more illumination beams and a diffraction lobe associated with the second pitch from a second of the one or more illumination beams, wherein the two selected mutually coherent diffraction lobes associated with the second image comprise a diffraction lobe associated with the second pitch from the first of the one or more illumination beams and a diffraction lobe associated with the first pitch from the second of the one or more illumination beams.

7. The overlay metrology system of claim 2, wherein the one or more illumination beams are mutually coherent, wherein the two selected mutually coherent diffraction lobes associated with the first image comprise a diffraction lobe associated with the first pitch from both of the one or more illumination beams, wherein the two selected mutually coherent diffraction lobes associated with the second image comprise a diffraction lobe associated with the second pitch from both of the one or more illumination beams.

8. The overlay metrology system of claim 2, wherein at least one of the first pitch, the second pitch, one or more wavelengths of the one or more illumination beams, or elements in the imaging sub-system are configured in accordance with the metrology recipe to provide that only the two selected mutually coherent diffraction lobes associated with the particular image are collected by the objective lens.

9. The overlay metrology system of claim 2, wherein the imaging sub-system further includes one or more blockers to selectively pass the two selected mutually coherent diffraction lobes associated with the particular image to an associated one of the one or more detectors and selectively block light associated with other diffraction lobes.

10. The overlay metrology system of claim 1, wherein the one or more images comprise a single image.

11. The overlay metrology system of claim 10, wherein the one or more illumination beams comprise a single illumination beam, wherein the two selected mutually coherent diffraction lobes associated with the single image comprise diffraction lobes associated with diffraction of the single illumination beam.

12. The overlay metrology system of claim 10, wherein the two selected mutually coherent diffraction lobes comprise a first double-diffraction lobe of a first of the one or more illumination beams by the overlapping grating structures and further comprise a second double-diffraction lobe of a second of the one or more illumination beams by the overlapping grating structures.

13. The overlay metrology system of claim 12, wherein the imaging sub-system further includes one or more blockers to selectively pass the first double-diffraction lobe and the second double-diffraction lobe and selectively block light associated with other diffraction lobes.

14. The overlay metrology system of claim 13, wherein the one or more blockers selectively block zero-order sidelobes associated with zero-order diffraction of the one or more illumination beams.

15. The overlay metrology system of claim 14, wherein the one or more blockers selectively block first-order diffraction from the overlapping grating structures.

16. The overlay metrology system of claim 1, wherein the overlay target in accordance with the metrology recipe comprises:
one or more PQ cells including a first Moiré structure having the first pitch (P) on a first layer of a sample and the second pitch (Q) on a second layer of the sample; and
one or more QP cells including a second Moiré structure having the second pitch on the first layer of the sample and the first pitch on the second layer of the sample.

17. An overlay metrology system comprising:
a controller including one or more processors configured to execute program instructions causing the one or more processors to implement a metrology recipe by generating one or more overlay measurements associated with one or more measurement directions based on one or more images of an overlay target from one or more detectors of an imaging sub-system, wherein the imaging sub-system generates the one or more images based on illumination with one or more illumination beams outside a numerical aperture of an objective lens used for imaging from opposing azimuth incidence angles rotated relative to the one or more measurement directions, wherein the overlay target in accordance with the metrology recipe includes one or more Moiré structures formed as overlapping grating structures with a first pitch and a second pitch, wherein a particular image of the one or more images is based exclusively on two selected mutually coherent diffraction lobes per measurement direction for at least one of the one or more measurement directions.

18. The overlay metrology system of claim 17, wherein the one or more images comprise a first image and a second image, wherein the imaging sub-system includes a first imaging channel to form the first image and a second imaging channel to form the second image.

19. The overlay metrology system of claim 18, wherein the two selected mutually coherent diffraction lobes associated with the first image comprise diffraction lobes associated with diffraction of a first of the one or more illumination beams at the first pitch and the second pitch, wherein the two selected mutually coherent diffraction lobes associated with the second image comprise diffraction lobes associated with diffraction of a second of the one or more illumination beams at the first pitch and the second pitch.

20. The overlay metrology system of claim 19, wherein the one or more illumination beams have different wavelengths.

21. The overlay metrology system of claim 19, wherein the one or more illumination beams have different polarizations.

22. The overlay metrology system of claim 18, wherein the one or more illumination beams are mutually coherent, wherein the two selected mutually coherent diffraction lobes associated with the first image comprise a diffraction lobe associated with the first pitch from a first of the one or more illumination beams and a diffraction lobe associated with the second pitch from a second of the one or more illumination beams, wherein the two selected mutually coherent diffraction lobes associated with the second image comprise a diffraction lobe associated with the second pitch from the first of the one or more illumination beams and a diffraction lobe associated with the first pitch from the second of the one or more illumination beams.

23. The overlay metrology system of claim 18, wherein the one or more illumination beams are mutually coherent, wherein the two selected mutually coherent diffraction lobes associated with the first image comprise a diffraction lobe associated with the first pitch from both of the one or more illumination beams, wherein the two selected mutually coherent diffraction lobes associated with the second image comprise a diffraction lobe associated with the second pitch from both of the one or more illumination beams.

24. The overlay metrology system of claim 18, wherein at least one of the first pitch, the second pitch, one or more wavelengths of the one or more illumination beams, or elements in the imaging sub-system are configured in accordance with the metrology recipe to provide that only the two selected mutually coherent diffraction lobes associated with the particular image are collected by the objective lens.

25. The overlay metrology system of claim 18, wherein the imaging sub-system further includes one or more blockers to selectively pass the two selected mutually coherent diffraction lobes associated with the particular image to an associated one of the one or more detectors and selectively block light associated with other diffraction lobes.

26. The overlay metrology system of claim 17, wherein the one or more images comprise a single image.

27. The overlay metrology system of claim 26, wherein the one or more illumination beams comprise a single illumination beam, wherein the two selected mutually coherent diffraction lobes associated with the single image comprise diffraction lobes associated with diffraction of the single illumination beam.

28. The overlay metrology system of claim 26, wherein the two selected mutually coherent diffraction lobes comprise a first double-diffraction lobe of a first of the one or more illumination beams by the overlapping grating structures and further comprise a second double-diffraction lobe of a second of the one or more illumination beams by the overlapping grating structures.

29. The overlay metrology system of claim 28, wherein the imaging sub-system further includes one or more blockers to selectively pass the first double-diffraction lobe and the second double-diffraction lobe and selectively block light associated with other diffraction lobes.

30. The overlay metrology system of claim 29, wherein the one or more blockers selectively block zero-order sidelobes associated with zero-order diffraction of the one or more illumination beams.

31. The overlay metrology system of claim 30, wherein the one or more blockers selectively block first-order diffraction from the overlapping grating structures.

32. The overlay metrology system of claim 17, wherein the overlay target in accordance with the metrology recipe comprises:
one or more PQ cells including a first Moiré structure having the first pitch (P) on a first layer of a sample and the second pitch (Q) on a second layer of the sample; and
one or more QP cells including a second Moiré structure having the second pitch on the first layer of the sample and the first pitch on the second layer of the sample.

33. An overlay metrology method comprising:
illuminating an overlay target on a sample with one or more illumination beams outside a numerical aperture of an objective lens used for imaging from opposing azimuth incidence angles rotated relative to one or more measurement directions, wherein the overlay target in accordance with a metrology recipe includes one or more Moiré structures formed as overlapping grating structures with a first pitch and a second pitch;
generating one or more images of the overlay target based on light collected by the objective lens, wherein a particular image of the one or more images is based exclusively on two selected mutually coherent diffraction lobes per measurement direction for at least one of the one or more measurement directions; and
generating one or more overlay measurements associated with the one or more measurement directions based on the one or more images.
